(19) United States
(12) Patent Application Publication
(10) Pub. No.: US 2008/0164221 A1
(43) Pub. Date: Jul. 10, 2008

(54) TUBE SOCK INCORPORATING MULTI-LAYER FILTER FOR ENABLING WASTE WATER DISCHARGE DIRECTLY INTO ENVIRONMENT

(76) Inventors: Jerry Brownstein, Issaquah, WA (US); Kathy Brownstein, Issaquah, WA (US); Brent Hepner, Maple Valley, WA (US); Mary Peacock, Gig Harbor, WA (US); Herb Pearse, Gig Harbor, WA (US)

Correspondence Address: LAW OFFICES OF RONALD M ANDERSON, 600 108TH AVE, NE, SUITE 507, BELLEVUE, WA, 98004, US

(21) Appl. No.: 12/028,260

(22) Filed: Feb. 8, 2008

Related U.S. Application Data
(63) Continuation-in-part of application No. 10/646,944, filed on Aug. 21, 2003, now abandoned.
Application No. 10/646,944 is a division of application No. 09/875,591, filed on Jun. 6, 2001, now Pat. No. 6,632,501.
(60) Provisional application No. 60/894,158, filed on Mar. 9, 2007.

(51) Int. Cl. B01D 35/30; B01D 37/00

(52) U.S. Cl. 210/767; 210/435

(57) ABSTRACT

A multi-layer filter sock is fabricated from materials selected to preferentially remove certain contaminants. For example, a first layer of the filter sock removes relatively fine particulates (such as rust), and another layer removes hydrocarbons. One exemplary hydrocarbon filter material can be made from delustered synthetic fibers. In one exemplary embodiment, the multi-layer filter sock includes an inner pre-filter layer configured to remove relatively larger particulates, another layer configured to remove relatively finer particulates, and a hydrocarbon removing layer. Such a filter sock can be used to remove rust from waste water used to flush fire suppression sprinkler systems, and particulates and hydrocarbons from waste water from underground vaults, enabling such waste water to be discharged directly into the ambient environment.

### RELATED APPLICATIONS

This application is based on a prior copending provisional application Ser. No. 60/894,158, filed on Mar. 9, 2007, the benefit of the filing date of which is hereby claimed under 35 U.S.C. § 119(e). This application is further a continuation-in-part of a copending patent application Ser. No. 10/646,944, filed on Aug. 21, 2003, which itself is a divisional application of co-pending patent application Ser. No. 09/875,591, filed on Jun. 6, 2001, issued as U.S. Pat. No. 6,632,501 on Oct. 14, 2003, the benefit of the filing dates of which is hereby claimed under 35 U.S.C. § 120.

### BACKGROUND

Contaminated water is generated by many different sources. Facilities such as factories and municipal sewage plants must treat relatively large volumes of contaminated water on a routine basis, and thus build permanent water treatment systems. However, contaminated water is also generated at facilities where permanent water treatment systems are not economically viable. Because environmental regulations generally preclude discharging anything but nominally contaminated water directly into the environment, contaminated water generated at a site that does not have a water treatment facility must either be flushed to a sanitary sewer for treatment at a municipal waste water treatment system, or trucked to an appropriate treatment facility. In general, municipal waste water treatment facilities have strict rules with respect to the types of contaminated water that can and cannot be flushed into the sewers. Alternative treatment sites (such as hazardous waste treatment and disposal facilities) do exist, but transportation and treatment costs can be significant. Hazardous waste treatment and disposal facilities are required to manage certain highly contaminated waste waters, or waste waters carrying a contaminant that is particularly toxic or environmentally dangerous. However, there are many occasions where a particular contaminated water stream cannot be discharged into sewers or directly into the environment because of regulatory or aesthetic concerns, but where the contamination is so minor that transportation to a hazardous waste treatment and disposal site for treatment and disposal is an inefficient use of resources.

Construction sites often generate industrial waste water contaminated with relatively environmentally benign sediments (e.g., dirt). Temporary on-site water treatment solutions have been developed to address such contaminated water streams, including temporary sedimentation basins, filter bags, and filter socks. Filter bags and filter socks are widely used in construction projects where there is no available space for a sedimentation basin, or if the volume of contaminated water to be treated is relatively small. Muddy, sediment-laden water is pumped from the project site and discharged into a filter bag/filter sock. The porous walls of the filter bag (generally a geo-textile) act as a filter that removes the sediment, enabling filtered water flowing out of the filter bag to be discharged into a stream or other open drainage system. The sediment is retained inside the filter bag, forming a filter cake. Filter bags are configured to be filled to capacity and release filter water gradually, whereas filter socks are generally configured to be placed at the outlet end of a hose or pipe, to remove mud/sedimentation from contaminated water in flow. Again, the porous walls of the filter sock act as a filter that removes the sediment, enabling filtered water to flow from the filter sock into the ambient environment.

Filter bags and filter socks are generally fabricated out of a heavy duty porous fabric, which exhibits relatively large pore sizes (i.e., much larger than 150 microns). Because mud and rock particles associated with contaminated water at construction sites are relatively large in size, relatively small pore sizes (i.e. pore sizes of 150 microns or less) are undesirable, since such relatively small pore sizes will rapidly become clogged, preventing flow through the material and rendering the filter bag or filter sock useless. Thus, conventional filter bags and filter socks are not suitable for removing fine particles from contaminated water.

When chemical contaminants, metals, fine particulates, or biological contaminants are present in water, conventional filter bags and filter socks cannot be safely employed, because conventional filter bags and filter socks do not reliably remove such contaminant materials. For this reason, it would be particularly desirable to provide a method and apparatus enabling water contaminated with hydrocarbons (such as oils, fuels, and greases) to be efficiently treated and discharged to the ambient environment. Underground vaults for electrical power equipment (such as transformers) are prone to accumulating water contaminated with hydrocarbons and particulate matter. Currently, such hydrocarbon and particulate contaminated water must be treated offsite, or complicated portable waste water treatment equipment must be brought onsite to treat the water. With respect to fine particulates, it would be particularly desirable to provide a method and apparatus enabling water contaminated with fine particles to be efficiently treated to remove the particulate contamination so that the water can be discharged into the ambient environment. With respect to metals, or biological contaminants, it would be particularly desirable to provide a method and apparatus enabling water contaminated with these contaminants to be efficiently treated to remove or reduce these contaminants, so that the water can be discharged into the ambient environment.

### SUMMARY

Disclosed herein is a filter sock configured to remove fine particulates (such as rust) and/or hydrocarbons from water, so that after filtering, the water can be discharged into the ambient environment, or into a sanitary sewer. Filter socks configured to remove dirt, mud, or environmentally benign sediments from water at construction sites cannot effectively remove such fine particulates, hydrocarbons. At least one embodiment of the filter sock disclosed herein has achieved the ability to meet regulatory agency guidelines for discharge levels of hydrocarbons and particulate matter. This embodiment can be used in treating waste water contaminated with rust, such as water purged from fire protection sprinkler systems, and/or hydrocarbon contaminated water from underground equipment vaults, so that these contaminated water streams can be economically treated onsite, and the treated water can then be discharged to the ambient environment. The embodiment exhibiting the ability to meet regulatory agency guidelines incorporates a 1 micron filter element. Standard regulatory tests for particulate matter employ a 1.5 micron filter, thus the use of a slightly smaller filter enables the filter sock disclosed herein to remove most particulates larger than 1.5 microns in size, so that water filtered with such a filter sock will pass water quality tests based on a 1.5 micron sized filter.

In one exemplary embodiment, a multi-layer filter sock is fabricated from materials selected to preferentially remove certain contaminants. For example, in one exemplary embodiment, one layer of the filter sock removes particulates larger than about 1 micron in size (applicants' empirical studies have shown that rusty water can be clarified using a 1 micron filter, and such a filter size enables regulatory guidelines for total suspended solids, TSS, to be met), and another layer removes hydrocarbons. A hydrocarbon filter material usable in this filter sock can be made from delustered synthetic fibers, as described in greater detail below. While such fibers can comprise an amorphous filter material, in at least some embodiments, delustered fibers are used to generate a non-woven fabric. Adjacent edges of planar sheets of material (such as the non-woven delustered synthetic fabric) can be sealed together to create an open ended elongate structure (i.e., a filter sock). It is contemplated that a single material might be employed to remove both fine particulates and hydrocarbons, so that a single layer can be used for the structure. In other embodiments, a plurality of layers will be included, since the order and configuration of such multiple layers can be chosen as required to remove specific contaminants.

A particularly useful 1 micron filter is a layered fabric structure, having a layer comprising 1 micron size pores, with a plurality of upper layers having progressively larger pore sizes. The bottommost layer is implemented with fibers having an extremely fine denier (the use of such a very fine denier appears to improve the quality of such a filter, thus, the finer the denier, the better the 1 micron filter). The denier of the fibers in the upper layers is progressively increased. For example, the bottom layer will comprise 1 micron pores, the next upper layer will comprise pores slightly larger than 1 micron, and the next upper layer will comprise still larger pore sizes. This gradual gradation in pore sizes enables such a 1 micron filter to accommodate relatively large flow rates without clogging. Because the filter sock is intended to remove contaminants in flow, it is important that the filter sock components be able to accommodate relatively high flow rates. Empirical testing indicated that single layer homogeneous 1 micron filters became clogged very quickly, and could not handle the flow rates desired. The graduated layered 1 micron filter described above exhibited a high loading capacity and very free flow. Empirical testing indicated the multi-layer 1 micron filter enabled removal of 99.5% of the fine particulates.

An exemplary (but not limiting) 1 micron layered filter is made out of polyester. Such 1 micron polyester filters are often marketed as air filters. Significantly, when such a layered polyester fabric is exposed to moisture, the fabric characteristically swells slightly. Thus, a polyester layered filter capable of removing particles down to 1 micron from air will likely remove some amount of sub-micron particles as well, due to swelling that causes some of the pores to decrease in size. Empirical evidence collected while employing a 1 micron layered polyester air filter in a filter sock as disclosed herein while filtering water indicates that such a filter sock removed particles smaller than one micron. This unexpected increase in performance has been attributed to swelling of the 1 micron layered polyester filter portion of the filter sock. Therefore, another aspect of the concepts disclosed herein is a filter sock including a layer configured to remove particles greater than 1 micron in size, as well as some amount of submicron particles as well. Such a filter is generally more effective at removing particles greater than 1 micron in size, but significantly, at least some submicron particles are removed as well.

In one exemplary embodiment, an inner pre-filter layer is employed, which is disposed before (i.e., upstream, relative to the contaminated water stream flow) the relatively fine particle removing layer (i.e., before the 1 micron filter layer). The pre-filter removes relatively larger particulates, to avoid overloading the fine particle removing layer, thus prolonging the life of the filter sock. A layer configured to remove particulars larger than about 150 microns can be used as an effective pre-filter, although it should be recognized that such a parameter (i.e., 150 microns) is exemplary, rather than limiting. An exemplary filter sock incorporating such a pre-filter includes an innermost pre-filter layer, a middle fine particulate removing layer, and an outer hydrocarbon removing layer. If desired, the positions of the fine particle removing layer and the hydrocarbon removing layer can be reversed.

Note that in a multi-layer filter sock, one or more layers can be implemented using an amorphous filter media. Alternatively, each layer can be implemented using generally planar sheets whose edges have been sealed to achieve a filter sock configuration (i.e., an elongate structure with a single opening, where the term “single opening” refers to an inlet configured to receive a relatively large quantity of water, as opposed to a plurality of smaller filter pores through which relatively smaller amounts of water can pass as the water is being filtered).

In some embodiments, particularly where an outer layer of the filter sock is relatively fragile, an outer protective porous layer can be employed to protect the more fragile inner layers. Note that the prior art filter socks that are used to remove clean sediment (i.e., non-chemically contaminated sediment) from waste water at construction sites can be used as a protective layer. Other materials that can be used as a protective layer include wire mesh, plastic mesh, and rugged fabrics.

In some embodiments, a porous structural support is included in the filter sock. Such a structural support is likely to be useful where the filter sock is used in turbulent conditions. A porous plastic material or metal material (such as a perforated pipe or a rugged mesh) can be disposed as an inner or outer layer of the multi-layer filter sock. In some embodiments, the porous structural support member is rigid.

One exemplary use of such a multi-layer filter sock is to remove rust from fire suppression sprinkler systems. Such systems must be regularly flushed to ensure proper performance, and the flushing procedure often produces a flow of rust-contaminated waste water. The rust is generally environmentally benign, but very aesthetically unappealing. Use of a filter sock configured to remove fine particulates (i.e., particles down to about 1 micron in size) enables clarified water to be discharged directly into the environment, without violating any environmental regulations or causing aesthetic concerns.

Another exemplary use of such a multi-layer filter sock is to remove hydrocarbons and hydrocarbon-borne contaminants from water pumped from underground equipment vaults (a process often referred to as vault dewatering). Such vaults are relatively common (many buildings include such a vault; electrical equipment such as transformers often being disposed in vaults). Currently, most polychlorinated biphenyl (PCB) transformers have been taken out of service, so any oil contamination in such vaults is not likely to be PCB contaminated. Test kits are available to confirm the absence of PCB contamination before treating such waste water with the filter socks disclosed herein (where PCB contamination is found, other treatment technologies specifically approved for removal of PCB contamination can be employed). Such vaults are regularly cleaned and inspected. Water collected in vaults or used to clean the vaults may be contaminated with hydrocarbons (i.e., oils, greases, solvent, fuels, etc.) from equipment used or stored therein. Use of a filter sock configured to remove hydrocarbons (and in some embodiments, fine particulates, as well) as well as hydrocarbon-borne contaminants, enables relatively clear water to be discharged directly into the environment, without violating any environmental regulations or causing aesthetic concerns.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 schematically illustrates a filter sock in accord with the concepts disclosed herein, including a single opening that serves as an inlet to receive contaminated water;

FIG. 2 schematically illustrates a plurality of different layers in a filter sock according to one exemplary embodiment disclosed herein;

FIG. 3A schematically illustrates a cross-sectional view of a single layer filter sock, illustrating how opposing edges of a generally planar sheet of material can be attached together to form a generally elongate filter sock;

FIG. 3B schematically illustrates a cross-sectional view of the filter sock embodiment of FIG. 2;

FIG. 3C schematically illustrates a cross-sectional view of a filter sock embodiment in which a porous structural member is disposed within the filter sock;

FIG. 3D schematically illustrates a cross-sectional view of a filter sock embodiment in which a porous structural member is disposed as the outer layer of the filter sock;

FIG. 3E schematically illustrates a cross-sectional view of an exemplary filter sock embodiment in which an amorphous filter material is sandwiched between two different annular layers of filter material;

FIG. 3F schematically illustrates a cross-sectional view of an exemplary filter sock embodiment in which an amorphous filter material is inserted in the core of the filter sock;

FIG. 3G schematically illustrates a cross-sectional view of an exemplary 1 micron filter for use as a fine particulate stage in the multi-stage filter socks disclosed herein;

FIG. 4 is a flow chart schematically illustrating an exemplary sequence of logical steps for treating contaminated water using the filter socks disclosed herein;

FIG. 5A is a schematic view of a filter media comprising a plurality of relatively long hydrophobic and lipophilic fibers intermingled with a plurality of relatively short hydrophobic and lipophilic fibers; and

FIG. 5B is an enlarged view of a portion of FIG. 5A.

### DESCRIPTION

### Figures and Disclosed Embodiments are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

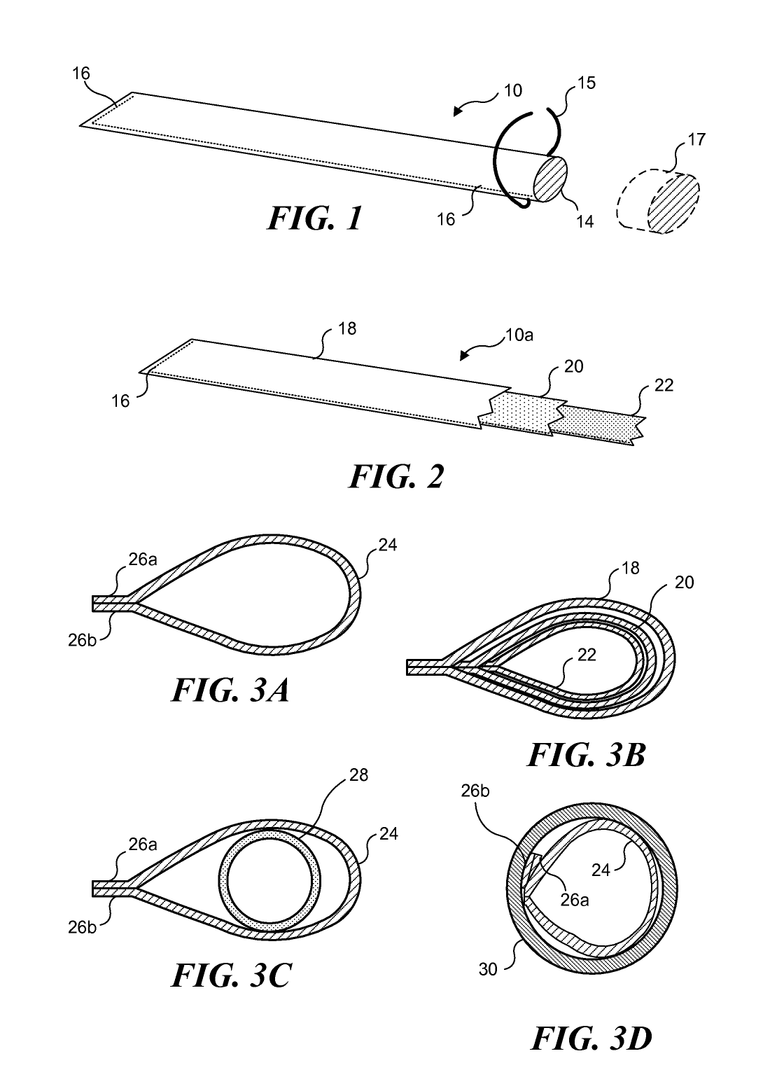

FIG. 1 schematically illustrates a filter sock 10 in accord with the concepts disclosed herein, including a single opening 14 that serves as an inlet to receive industrial waste water. Opening 14 engages a tube, pipe, hose or stream of water to be filtered. A fastener 15 can be used to secure the open end of filter sock 10 to the tube, pipe, or hose discharging the contaminated water. It should be recognized that many types of fasteners can be employed, including but not limited to clamps, cordage, and banding material. An optional coupling 17 can be attached to filter sock 10 proximate to opening 14, to facilitate attaching filter sock 10 to the source of the contaminated water. Unlike conventional filter socks, filter sock 10 includes one or more layers specifically configured to remove one or more of fine particulates (such as rust), and chemical contamination (preferably hydrocarbons) from a contaminated water stream. It should be recognized that other types of contaminants, such as biological materials and metals, can also be removed from contaminated water, so long as the appropriate filter media is incorporated into one or more layers of the filter sock.

The length and diameter of filter sock 10 can be varied as desired, it being understood that longer lengths and larger diameters will be better able to accommodate larger volumes of contaminated water. In at least one exemplary embodiment, filter sock 10 is man portable, and designed to couple with standard industrial hoses used in conjunction with vacuum trucks and pumps.

Filter sock 10 can be fabricated using a variety of techniques. A particularly useful technique involves starting with a generally planar sheet of filter material that is folded lengthwise to bring opposing edges into overlapping contact with each other, and then sealing the opposed edges together. The opposed edges can be joined in a variety of ways, including, but not limited to, sewing, welding, clamping, bonding or otherwise suitably joining the opposed edges to generate a generally elongate filter sock open at two ends (i.e., to form a generally tubular structure). One end of the generally elongate structure is then sealed using any similar technique. Seams 16 are generally indicative of such joining, although it should be understood that the term “seam,” as used herein, is not intended to be limiting with respect to any particular technique being employed to seal the edges of the filter sock together.

While a single type of filter material (such as a non woven delustered synthetic fabric, although such filter material is intended to be exemplary, and not limiting) could be selected to provide fine particulate filtering (recognizing that fine particulates is generally intended to refer to particulates ranging from about 1 micron to about 150 microns, although such a range is intended to be exemplary, rather than limiting) as well as hydrocarbon filtering, the use of a plurality of different filter layers generally enables more flexible and cost effective filters to be achieved. FIG. 2 schematically illustrates a plurality of different layers in a filter sock 10a, according to one embodiment disclosed herein. In general, each different layer will serve a specific primary function, although some layers may also perform one or more additional functions, as well. It should be recognized that no specific number of layers is required. However, an exemplary embodiment of a particularly useful multi-layer filter sock can be implemented using three different layers, as indicated in FIG. 2.

Filter sock 10a includes an inner layer 22, a mid layer 20, and an outer layer 18. The primary function of inner layer 22 is to serve as a pre-filter, removing relatively larger particles, to avoid overloading a finer filter implemented in mid layer 20. In an exemplary, but not limiting embodiment, inner layer 22 is configured to remove particles larger than about 150 microns. In a particularly preferred embodiment, inner layer 22 is implemented using a non-woven delustered synthetic fiber fabric, which will remove relatively larger particles. The use of the non-woven delustered synthetic fiber fabric to implement the inner layer enables the inner layer to serve a secondary function, since such a non-woven delustered synthetic fiber fabric will also remove at least some of the hydrocarbons from the waste water. Alternatively, inner layer 22 can be implemented using a material (such as a polymer or metal mesh) that only removes relatively larger particulates, as opposed to removing particulates and hydrocarbons.

Mid layer 20 is configured to remove relatively finer particulates. In an exemplary, but not limiting embodiment, mid layer 20 is configured to remove particles larger than about 1 micron. Empirical studies conducted during the development of the filter sock disclosed herein have indicated that a filter sock configured to remove relatively fine particles down to about 1 micron in size can substantially clarify rusty water, enabling such water to be discharged directly into the ambient environment, without causing any environmental or aesthetic concerns. When combined with a pre-filter layer to avoid overloading the 1 micron filter, a reliable and long lasting filter sock can be achieved. A variety of different 1 micron filter materials are available. An empirical device fabricated and used for testing employed a 1 micron polyester-based felted fabric material. However, it should be recognized that such a material is intended to be exemplary, rather than limiting.

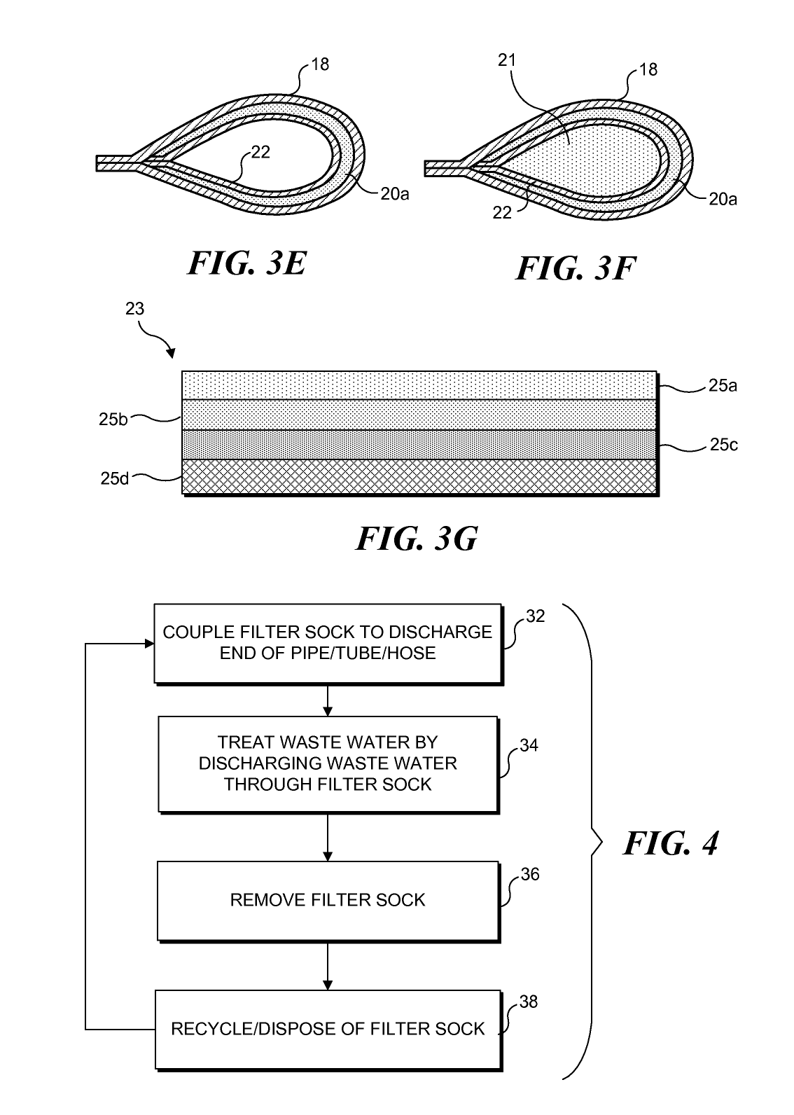

FIG. 3G schematically illustrates a cross-sectional view of an exemplary 1 micron filter, a layered fabric filter structure 23, having a layer 25d comprising 1 micron size pores, with a plurality of upper layers 25a-25c, each layer having progressively larger pore sizes. It should be noted that the specific number of upper layers 25a-25c can be varied as desired. While adding more upper layers will likely increase the cost of the layered filter, additional upper layers are likely to increase the holding capacity of the layered 1 micron filter, as well as reducing the likelihood that the filter will become overburdened and flow rates will drop. The bottommost layer 25d is implemented with fibers having an extremely fine denier (the use of such a very fine denier appears to improve the quality of such a filter, thus, the finer the denier, the better the 1 micron filter). The denier of the fibers in the upper layers is progressively increased. For example, the bottom layer will comprise 1 micron pores, the next upper layer will comprise pores slightly larger than 1 micron (controlled by the use of a slightly larger fiber denier), and the next upper layer will comprise still larger pore sizes. In other words; layer 25a is characterized by relatively larger pore sizes and relatively larger fiber deniers than other layers; layer 25b is characterized by relatively smaller pore sizes and relatively smaller fiber deniers than in layer 25a; layer 25c is characterized by relatively smaller pore sizes and relatively smaller fiber deniers than in layer 25b; and layer 25d is characterized by relatively smaller pore sizes and relatively smaller fiber deniers than in layer 25c. This gradual gradation in pore sizes/fiber deniers enables such a 1 micron filter to accommodate relatively large flow rates without clogging. Because the filter sock is intended to remove contaminants in flow, it is important that the filter sock components be able to accommodate relatively high flow rates. Empirical testing indicated that single layer homogeneous 1 micron filters became clogged very quickly, and could not handle the flow rates desired. The graduated layered 1 micron filter described above exhibited a high loading capacity and very free flow.

Referring to any of FIGS. 2 and 3B, 3E, and 3F, outer layer 18 is configured to remove hydrocarbons. Where inner layer 22 removes only relatively larger particulates (and not particulates and hydrocarbons), outer layer 18 is responsible for removing the hydrocarbons. Where inner layer 22 removes hydrocarbons as well, outer layer 18 removes any hydrocarbons missed by inner layer 22 (and thus may act as a polishing filter, depending on how much of the hydrocarbons are removed by the inner layer). An exemplary material for removing hydrocarbons is a non-woven delustered synthetic fiber fabric, which will be described in greater detail below. It should be recognized that other types of filter materials that are characterized by their ability to remove hydrocarbons from water can alternatively be employed.

With respect to FIG. 2, it should be recognized that each of the three layers can be implemented with a single layer of material, or with multiple layers of materials (either bonded together to form a unitary layer, or as separate layers).

FIG. 3A schematically illustrates a cross-sectional view of an exemplary single layer filter sock, illustrating one way in which opposite edges 26a and 26b of a generally planar sheet of material 24 can be overlapped and attached together to form a generally elongate filter sock. FIG. 3B schematically shows a cross-sectional view of the filter sock of FIG. 2, illustrating how each individual layer can be implemented using a similar sheet of filter material.

Under certain conditions (such as a turbulent flow of waste water) it may be desirable to incorporate a porous structural support member into one or more of the exemplary embodiments of the filter socks disclosed herein. FIG. 3C schematically illustrates a cross-sectional view of such an embodiment, in which a porous structural member 28 is disposed within the filter sock of FIG. 3A (recognizing that such support members can be implemented in any filter sock design disclosed herein, and not just the embodiment of FIG. 3A). FIG. 3D schematically illustrates a cross-sectional view of an exemplary filter sock embodiment in which a porous structural member 30 is employed as the outer layer of the filter sock. A porous plastic material or metal material (such as a perforated pipe or a rugged mesh) can be used to implement the porous structural support member, which in some embodiments, can be rigid.

While the exemplary filter socks disclosed above have employed generally planar sheets for each layer in a multi-layer filter sock, it should be recognized that one or more layers can be implemented using amorphous filter materials that are disposed in voids within the filter sock. FIG. 3E schematically illustrates a cross-sectional view of a filter sock embodiment in which an amorphous filter material 20a is sandwiched between two different annular layers of filter material. Note that FIG. 3E illustrates an exemplary filter that is functionally similar to that of FIG. 2, except for implementing the mid layer using an amorphous filter media, rather than a sheet filter. Furthermore, it should be recognized that other layers (i.e., layers other than mid layer 20 of FIG. 2) could be implemented using amorphous filter media. FIG. 3F schematically illustrates a cross-sectional view of a filter sock embodiment in which an amorphous filter material 21 is disposed in a core of the filter sock.

Clearly, individual layers can be implemented using sheets of material (suitably joined together as described above) or amorphous filter media. While a filter sock can specifically be configured to remove relatively fine particulates and hydrocarbons, it should be recognized that many different types of filter media can be employed to selectively remove specific contaminants. If desired, filter socks can be specifically configured to enable contaminated water to be treated in-situ and discharged into the ambient environment, in compliance with environmental discharge requirements. Thus, if a specific type of waste water includes a specific contaminant (other than fine particles or hydrocarbons), a filter media specifically selected to remove that contaminant can be added to the filter sock as an additional layer, as part of one or more of the layers discussed above, or as a replacement to one or more of the layers discussed above. For example, an anti-microbial agent could be added to one or more layers, in order to reduce biological contamination.

FIG. 4 is a flow chart schematically illustrating an exemplary sequence of logical steps for treating contaminated water using any of the exemplary filter socks disclosed herein. In a first step represented by a block 32, a filter sock is coupled to a source of the contaminated water or the contaminated water is otherwise directed into the filter sock. Such a source is generally the outlet end of a pipe, a hose, or a tube through which the waste water is being discharged, although other types of ports can be employed, including a stream of contaminated water directed into or otherwise made to enter the filter sock. In the next step, represented by a block 34, the contaminated water is treated/filtered as it passes through the filter sock. As discussed above, the three layer filter sock of FIG. 2 has been empirically shown to remove rust from waste water drained from fire suppression sprinkler systems, and hydrocarbon and particulates from contaminated water drawn from storage vaults, such that the resulting filtered water can be discharged directly into the ambient environment (or into a sanitary sewer). It should be recognized that other multi-layer filter socks, having filter layers specifically selected to remove another specific type of contaminant from a waste water, can be readily implemented in accord with the disclosure provided herein. In another step, indicated by a block 36, the spent filter sock is removed and is recycled or disposed of, as indicated by a block 38, representing the final step.

As noted above, one exemplary use of a multi-layer filter sock is to remove rust from water flushed through fire suppression sprinkler systems. Such systems must be regularly flushed to ensure proper performance, and the process of flushing generally produces a volume of rust-contaminated waste water. The rust is generally environmentally benign, but very aesthetically unappealing. Use of a filter sock configured to remove fine particulates (i.e., particles down to about 1 micron) from the rust laden waste water enables relatively clear water to be discharged directly into the environment, without violating any environmental regulations or causing aesthetic concerns. Another exemplary use of a multi-layer filter sock is to remove hydrocarbons from water pumped from underground equipment vaults. Water collected in such vaults or used to clean such vaults may be contaminated with hydrocarbons (i.e., oils, greases, solvent, fuels, etc.) derived from equipment used or stored therein. Use of a filter sock configured to remove hydrocarbons (and in some embodiments, fine particulates as well) enables the contaminated water to be filtered so that relatively contaminant free water can be discharged directly into the environment, without violating any environmental regulations or causing aesthetic concerns.

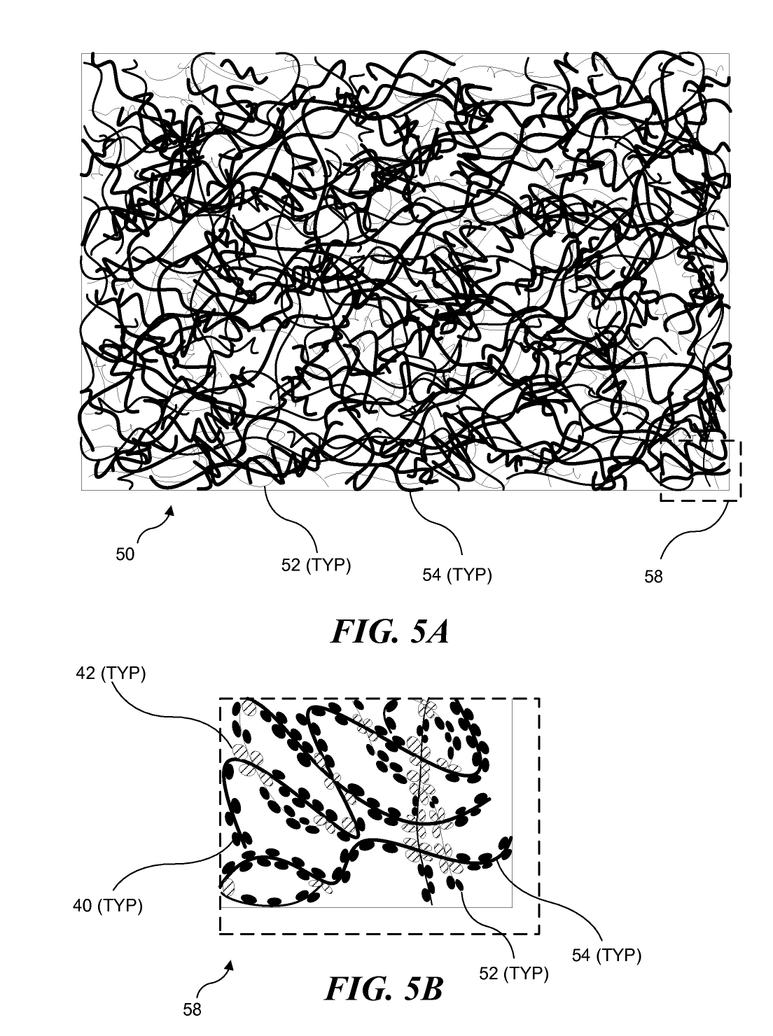

FIGS. 5A and 5B provide details relating to the efficient sorbent material (details of this type of sorbent material are described in commonly assigned U.S. Pat. No. 6,632,501, the drawings and specification of which have been specifically incorporated herein by reference) utilized in the test filter of FIG. 2 for removing rust and hydrocarbons. Such a filter media is characterized by its oil absorbance, the provision of vast interstitial spaces, and by its ability to allow a free flow of water through the material. This type of filter media is available as an amorphous bulk material and as a non-woven textile or fabric. The exact proportions of the individual fibers are not critical, although a majority of the fibers should be synthetic, and only a minority of the fibers should be natural. The majority of synthetic fibers are hydrophobic and lipophilic (i.e., capable of adsorbing hydrocarbon products). Synthetic fibers such as polyester, nylon, acrylic, and triacetate can be beneficially employed for the majority of fibers. In one exemplary embodiment, approximately 70% of the fibers are polyester, approximately 20% of the fibers are nylon, less than about 2% of the fibers are acrylic, and less than about 1% of the fibers are triacetate; however, the relative percentages of these fibers in the filter media can vary considerably and still provide a useful sorbent, since each of the fibers individually meet the criteria of being hydrophobic and lipophilic (capable of sorbing a hydrocarbon).

It has been determined that delustering enhances the sorbency of synthetic fibers, which inherently have a sheen due to their smooth outer surface. The delustering effect has been empirically determined, and it is believed that at least two mechanisms are responsible for the increase in the sorbency of delustered fibers. First, delustering significantly roughens the surface of individual fibers, substantially increasing the surface area of each fiber, and thus enabling a greater amount of adsorption per fiber. Second, it should be noted that rough surfaces of the individual fibers, in combination with the mix of short and long fiber lengths, enable a surprisingly cohesive wad of fiber sorbent to be achieved. The rough surfaces provide fiber-to-fiber traction, enabling adjacent fibers to better adhere to one another. The mix of a minor portion of relatively long fibers with a majority of relatively short fibers ensures that sufficient relatively long fibers are present to help bind the wadded mass together without the need for binding agents typically employed to bind amorphous masses of fiber together. This wadded mass configuration ensures that a significant amount of interstitial volume is available for absorption/adsorption of contaminants. Thus, delustering is believed to enhance sorption by providing more sites for both adsorption and absorption to occur. Absorption will occur in interstitial regions within the wadded mass. Delustering using titanium dioxide is one effective technique, since it adds a significant amount of surface area to each individual fiber surface, as well as helping the fibers maintain a wadded mass configuration in which a plurality of interstitial volumes are available for absorption.

If virgin synthetic fibers are to be used to produce a sorbent for use in a hydrocarbon adsorbing filter layer in accord with the concepts disclosed herein, such virgin synthetic fibers can be delustered to enhance their oil absorbency properties. If recycled synthetic textile products are shredded to generate a fiber sorbent, further delustering is not likely to be required, because the majority of synthetic fibers used in the textile industry are delustered to enhance their value in textiles. It should be noted that while a mixture of a majority of delustered synthetic fibers and a minority of natural fibers provides better absorbency, a particularly useful filter media can also be produced using only synthetic fibers. A filter media comprising only (or a majority of) natural fibers is less desirable, because such natural fibers do not have the affinity for oil and other hydrocarbons that synthetic fibers exhibit.

A wadded mass/non-woven textile 50 comprising a majority of delustered synthetic fibers and a minority of natural fibers is schematically illustrated in FIG. 5A. A plurality of generally delustered synthetic fibers 52 are intermingled with a relatively small amount of natural fibers 54. The natural fibers are not strictly required (i.e., a beneficial filter media can be achieved using entirely synthetic fibers), but when recycled fibers are being employed, it is difficult to obtain a large volume of synthetic fibers that does not also include a minor portion of natural fibers. A mixture of a minority of relatively long fibers and a majority of relatively short fibers can enhance the sorbent because the minority of relatively long fibers bind the mass of interleaved fibers (both long and short) together into a desirable cohesive wadded mass. Furthermore, the majority of relatively short fibers considerably increase the surface area associated with the wadded mass/non-woven textile. Empirical testing has confirmed that a large surface area is key to a sorbent that begins sorbing material very rapidly, as well as being an important factor in achieving a sorbent that has a high capacity to absorb hydrocarbons.

FIG. 5B, which illustrates an enlarged view of a portion 58 of FIG. 5A, shows how wadded mass/non-woven textile 50 provides a sorbent that exhibits both adsorbent capabilities, as well as absorbent capabilities. Hydrocarbon products 40 are adsorbed on individual surfaces of both synthetic fibers 52 and natural fibers 54 (although, primarily on the synthetic fibers). Hydrocarbon products 42 are absorbed into the interstitial spaces within wadded mass/non-woven textile 50, proximate to locations where the interleaved fibers cross each other.

While the use of the delustered synthetic fiber sorbent described above in the form of a non-woven fabric enables a particularly useful filter sock to be provided, it should be recognized that filter socks employing the delustered synthetic fiber sorbent in bulk form (i.e., amorphous bulk fibers) can also be implemented consistent with the concepts disclosed herein. With respect to the exemplary multi-layer filter sock of FIG. 2, which includes a pre-filter layer for removing relatively larger particulates, a hydrocarbon removing layer, and a relatively fine particulate removing layer, note that a similar filter sock can be achieved as follows. The inner pre-filter layer can be implemented using a wire or polymer mesh configured to remove relatively larger particulates, or a fabric filter configured to remove relatively larger particulates. The relatively fine particulate removing layer can be implemented using a wire or polymer mesh configured to remove relatively smaller particulates, or a fabric filter configured to remove relatively smaller particulates. The hydrocarbon removing layer can be implemented by dispersing the delustered synthetic fiber sorbent in bulk/amorphous form between the fine and course particulate removing layers (note FIG. 3E schematically illustrates such a configuration). If desired, a porous protective cover could be used to encompass such a multi-layer filter, to provide protection to the relatively fine particle removing layer, which likely will be relatively fragile.

It should be recognized that the discussion above employs both the terms absorb (and absorbent) and adsorb (and adsorbent). In general, the term “adsorb” is associated with a physical process whereby a fluid (generally a liquid) is attracted to the physical surface of a material. Similarly, the term “absorb” is generally associated with a physical process whereby a fluid (generally a liquid) is trapped in a volume defined in a material (like the pores in a sponge). Particularly with respect to the exemplary delustered synthetic fiber-based sorbent material described in detail above, both the terms adsorb and absorb apply to the exemplary material. In amorphous bulk form and in fabric form, the exemplary delustered synthetic fiber based material exhibits a large volume of interstitial spaces into which a liquid can be absorbed. Furthermore, the delustered synthetic fibers themselves have a very large surface area onto which a liquid can be adsorbed. Thus, a delustered synthetic fiber based filter material is both an adsorbent and an absorbent.

Although the concepts disclosed herein have been described in connection with the preferred form of practicing them and modifications thereto, those of ordinary skill in the art will understand that many other modifications can be made thereto within the scope of the claims that follow. In particular, it should be recognized that fabrics and filter media other than those specifically described herein can be employed, and that the specific number of layers can vary. Accordingly, it is not intended that the scope of these concepts in any way be limited by the above description, but instead be determined entirely by reference to the claims that follow.

The invention in which an exclusive right is claimed is defined by the following:

1. A multi-layer water filter, comprising a generally elongate body having a single opening, the single opening being configured to be coupled to at least one element selected from the group consisting essentially of a pipe, a tube, and a hose, the generally elongate body comprising a plurality of different layers, each layer having different filtration properties, the multi-layer water filter comprising a material selected to remove from water at least one contaminant selected from the group consisting essentially of particulates greater than about 1 micron in size and hydrocarbons.

2. The water filter of claim 1, wherein the generally elongate body comprises a plurality of different layers, the plurality of different layers comprising:
(a) an inner layer configured to act as a pre-filter that removes at least one contaminant selected from the group consisting essentially of relatively larger particulates and hydrocarbons;
(b) a middle layer configured to remove at least one contaminant selected from the group consisting essentially of relatively smaller particulates and hydrocarbons; and
(c) an outer layer configured to remove hydrocarbons.

3. The water filter of claim 2, wherein the inner layer removes both relatively larger particulates and hydrocarbons.

4. The water filter of claim 2, wherein the inner layer removes particles larger than about 150 microns in size.

5. The water filter of claim 4, wherein the inner layer comprises at least one element selected from a group consisting essentially of:
(a) a non-woven fabric comprising delustered synthetic fibers; and
(b) a metal mesh, which provides structural support as well as particulate removal.

6. The water filter of claim 2, wherein the middle layer removes particles larger than about 1 micron in size.

7. The water filter of claim 6, wherein the middle layer comprises a multi-layer 1 micron filter, the multi-layers comprising a bottommost layer characterized by a relatively finer fiber denier and a relatively smaller pore size, the upper layers being characterized by progressively coarser fiber deniers and relatively larger pore sizes, moving away from the bottommost layer.

8. The water filter of claim 7, wherein the middle layer comprises a layered fabric that swells when exposed to moisture, and removes at least some submicron particles in addition to particles greater than 1 micron.

9. The water filter of claim 2, wherein the middle layer comprises at least one element selected from a group consisting essentially of:
(a) a synthetic felted filter material; and
(b) a non-homogenous layered filter media.

10. The water filter of claim 2, wherein the outer layer comprises at least one element selected from a group consisting essentially of:
(a) a non-woven fabric comprising delustered synthetic fibers; and
(b) a layer that is thicker than the inner layer.

11. The water filter of claim 2, further comprising an outer protective layer of porous material, the outer protective layer being fabricated from a more durable material than the outer layer, to protect the outer layer from being damaged.

12. The water filter of claim 1, further comprising at least one element selected from a group consisting essentially of:
(a) a collar that is configured to facilitate coupling the single opening with the at least one of the hose, the tube, and the pipe; and
(b) a porous structural support member.

13. A filter sock comprising a generally elongate body having a single opening, the single opening being configured to be coupled to a discharge port, the generally elongate body comprising a plurality of different layers, the plurality of different layers comprising:
(a) a first layer configured to selectively remove particulates larger than a predefined size, the predefined size ranging from about 1 micron to about 150 microns; and
(b) a second layer configured to remove hydrocarbons.

14. The filter sock of claim 13, wherein the first layer removes particles larger than about 1 micron in size.

15. The filter sock of claim 14, wherein the first layer comprises a multi-layer 1 micron filter, the multi-layers comprising a bottommost layer characterized by a relatively finer fiber denier and a relatively smaller pore size, the upper layers being characterized by progressively coarser fiber deniers and relatively larger pore sizes, moving away from the bottommost layer.

16. The filter sock of claim 13, wherein the second layer comprises a non-woven fabric comprising delustered synthetic fibers.

17. The filter sock of claim 13, further comprising at least one element selected from the group consisting essentially of:
(a) a porous structural support member;
(b) an outer protective layer of porous material, the outer protective layer being fabricated from a more durable material than the first and second layers, to protect the first and second layers from being damaged;
(c) an inner layer configured to act as a pre-filter, to remove relatively larger particles thereby avoiding overloading the first layer; the inner layer being disposed closer to a core of the filter sock than the first layer; and
(d) a collar that is configured to facilitate coupling the single opening with the discharge port.

18. A method for treating waste water having relatively low levels of contaminants in-situ, such that the waste water need not be transported to a waste water treatment plant for processing, the method comprising the steps of:
(a) attaching a multi-layer filter sock to a discharge port through which the waste water is to be discharged, the multi-layer filter sock being configured to remove at least hydrocarbons and particulates larger than a predefined size, the predefined size ranging from about 1 micron to about 150 microns; and
(b) discharging waste water through the discharge port, such that the waste water is filtered by the multi-layer filter sock, thereby treating the waste water in-situ, by removing hydrocarbons and particulates larger than the predefined size.

19. The method of claim 18, wherein the source of the waste water comprises at least one source selected from a group consisting essentially of:
(a) an electrical equipment vault;
(b) an underground equipment vault;
(c) an equipment vault;
(d) a storage vault; and
(e) a sprinkler system.

20. The method of claim 18, wherein the step of attaching the multi-layer filter sock to the discharge port comprises the step of attaching a multi-layer filter sock comprising:
(a) a first layer configured to act as a pre-filter that removes at least one contaminant selected from the group consisting essentially of relatively coarser particulates that are larger than the predefined size and hydrocarbons; and
(b) a second layer configured to remove relatively finer particulates that are larger than the predefined size, the first layer and the second layer being configured such that the waste water passes through the first layer before reaching the second layer.

21. The method of claim 18, wherein the step of attaching the multi-layer filter sock to the discharge port comprises the step of attaching a multi-layer filter sock comprising:
(a) a first layer configured to remove hydrocarbons; and
(b) a second layer configured to remove particulates larger than the predefined size, the second layer comprising a multi-layer 1 micron filter, the multi-layers comprising a bottommost layer characterized by a relatively finer fiber denier and a relatively smaller pore size, the upper layers being characterized by progressively coarser fiber deniers and relatively larger pore sizes, moving away from the bottommost layer.

22. The method of claim 21, wherein the step of attaching the multi-layer filter sock to the discharge port further comprises the step of attaching a multi-layer filter sock in which the second layer comprises a layered polyester fabric that swells when exposed to moisture, and removes at least some submicron particles in addition to particles greater than 1 micron.

23. A method for treating rust laden waste water from fire suppression sprinkler systems in-situ, such that the rust laden waste water need not be transported to a waste water treatment plant for processing, the method comprising the steps of:
(a) attaching a filter sock to a discharge port through which the rust laden waste water is to be discharged, the filter sock being configured to remove particulates larger than a predefined size, the predefined size ranging from about 1 micron to about 150 microns; and
(b) discharging rust laden waste water through the discharge port, such that the rust laden waste water is filtered by the filter sock, thereby treating the rust laden waste water in-situ, by removing particulates larger than the predefined size.

24. The method of claim 23, wherein the step of attaching the filter sock to a discharge port through which the rust laden waste water is to be discharged comprises the step of attaching a multi-layer filter sock comprising a multi-layer 1 micron filter, the multi-layers comprising a bottommost layer characterized by a relatively finer fiber denier and a relatively smaller pore size, the upper layers being characterized by progressively coarser fiber deniers and relatively larger pore sizes, moving away from the bottommost layer.

25. The method of claim 23, wherein the step of attaching the filter sock to a discharge port through which the rust laden waste water is to be discharged comprises the step of attaching a multi-layer filter sock selected from a group consisting of:
(a) a first multi-layer filter comprising a first layer configured to remove hydrocarbons and a second layer configured to remove particulates larger than the predefined size, the second layer comprising a multi-layer 1 micron filter, the multi-layers comprising a bottommost layer characterized by a relatively finer fiber denier and a relatively smaller pore size, the upper layers being characterized by progressively coarser fiber deniers and relatively larger pore sizes, moving away from the bottommost layer; and
(b) a second multi-layer filter comprising a first layer configured to act as a pre-filter that removes at least one contaminant selected from the group consisting essentially of relatively coarser particulates that are larger than the predefined size and hydrocarbons, and a second layer configured to remove relatively finer particulates that are larger than the predefined size, the first layer and the second layer being configured such that the rust laden waste water passes through the first layer before reaching the second layer.

26. A method for dewatering a vault and treating vault waste water in-situ, such that the vault waste water need not be transported to a waste water treatment plant for processing, the method comprising the steps of:
(a) attaching a multi-layer filter sock to a discharge port through which the industrial waste water is to be discharged, the multi-layer filter sock being configured to remove at least hydrocarbons and particulates larger than a predefined size, the predefined size ranging from about 1 micron to about 150 microns; and
(b) discharging vault waste water through the discharge port, such that the vault waste water is filtered by the multi-layer filter sock, thereby treating the vault waste water in-situ, by removing hydrocarbons and particulates larger than the predefined size.

27. The method of claim 26, wherein the step of attaching the multi-layer filter sock to a discharge port through which the vault waste water is to be discharged comprises the step of attaching a multi-layer filter sock selected from a group consisting of:
(a) a first multi-layer filter comprising a first layer configured to remove hydrocarbons and a second layer configured to remove particulates larger than the predefined size, the second layer comprising a multi-layer 1 micron filter, the multi-layers comprising a bottommost layer characterized by a relatively finer fiber denier and a relatively smaller pore size, the upper layers being characterized by progressively coarser fiber deniers and relatively larger pore sizes, moving away from the bottommost layer; and
(b) a second multi-layer filter comprising a first layer configured to act as a pre-filter that removes particulates substantially larger than the predefined size and hydrocarbons, and a second layer configured to remove particulates larger than the predefined size, the first layer and the second layer being configured such that the vault waste water passes through the first layer before reaching the second layer.
